(19) United States
(12) Patent Application Publication
(10) Pub. No.: US 2024/0320293 A1
(43) Pub. Date: Sep. 26, 2024

(54) SMART THREADING IN MATRIX MULTIPLICATION

(71) Applicant: ADVANCED MICRO DEVICES, INC., Santa Clara, CA (US)

(72) Inventors: Nallani Bhaskar, Bangalore (IN); Mithun Mohan Kadavil Madana Mohanan, Thrissur (IN)

(21) Appl. No.: 18/125,454

(22) Filed: Mar. 23, 2023

(51) Int. Cl. G06F 17/16; G06F 9/48

(52) U.S. Cl. CPC G06F 17/16; G06F 9/4881

(57) ABSTRACT

Techniques are described in which an estimated optimal thread quantity for matrix multiplication is determined and implemented based on dimensions of the input matrices being multiplied and one or more kernel parameters that vary based on processor architecture. An efficient factorization of the estimated optimal thread quantity is based on a number of blocks along a first dimension of a first input matrix, and a number of blocks along a dimension n of a second input matrix B, with both numbers being based on the kernel parameters. In certain embodiments, a command processor of a parallel processor determines an estimated optimal thread quantity for performing a matrix multiplication command responsive to receiving the matrix multiplication command, and then schedules that estimated optimal thread quantity of kernel threads to execute the matrix multiplication command in parallel.

### BACKGROUND

Processing units such as a graphics processing unit (GPU) or other parallel processor or a central processing unit (CPU) typically implement multiple processing elements (referred to as compute units in the case of the GPU and processor cores in the case of a CPU) that execute instructions concurrently or in parallel. For example, the compute units in a GPU execute a kernel (a small set of executable instructions that is typically used as a building block for larger GPU programs, and optimized for performing a specific, low-level task, such as matrix multiplication or convolution) using a number of workgroups, each workgroup including a multiple number of threads executing the same instructions on different input data. The instructions in the kernel may represent shaders that perform graphics processing, neural networks that perform machine learning tasks, and the like. A processing unit also includes a command processor that fetches commands from command buffers, allocates resources, and schedules the commands for execution on one or more of the processing elements in the processing unit.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system 100 configured to dynamically determine and implement an estimated optimal thread quantity for matrix multiplication operations performed in accordance with some embodiments.

FIG. 2 illustrates an example of work distribution for a plurality of kernel threads performing multiplication of an input source matrix and an input weight matrix.

FIG. 3 illustrates two contrasting examples of work distribution for a plurality of kernel threads performing multiplication of an input source matrix and an input weight matrix.

FIG. 4 illustrates two contrasting examples of work distribution for a plurality of kernel threads performing one or more operations on an arbitrary matrix.

FIG. 5 illustrates an example of work distribution for a plurality of kernel threads performing one or more operations on an arbitrary matrix.

FIG. 6 is a flow diagram illustrating an operational routine for determining and implementing an estimated optimal thread quantity for executing a matrix multiplication kernel operation, in accordance with some embodiments.

FIG. 7 is a programmatic flow diagram illustrating an operational routine for determining an estimated optimal thread quantity for executing a matrix multiplication kernel operation, in accordance with some embodiments.

### DETAILED DESCRIPTION

Low-level matrix multiplication is used by various high-performance computing (HPC) and machine learning (MIL) applications and is expected to be high performant in those and other contexts. Workloads from artificial intelligence (AI) and HPC domains perform matrix multiplication with inputs matrices of various shapes (e.g., large, small, skinny, square, wide, etc.), all of which shapes can affect the memory access patterns and computation efficiency associated with the resulting matrix multiplication process.

Prior attempts to increase performance in matrix multiplication have involved utilizing all available processing cores and/or all available threads. However, such attempts often result in performance degradation in scenarios in which one or both of the input matrices are small (one that has a relatively low number of rows and columns) or skinny (one that has many more columns than rows, or vice-versa). Additionally, the distribution of work in such attempts that is, the factorization of the input matrices between threads does not typically account for data access patterns within the relevant memory hierarchy.

In fact, high performance in matrix multiplication is not achieved by simply utilizing all available threads, but rather by more efficient utilization of an optimal quantity of threads. As discussed herein, an optimal thread quantity (also referred to herein as a target thread quantity) is the number of threads to be utilized in order to achieve the best performance (e.g., as measured in billions of floating point operations per second, or gigaflops) for a given input. However, the optimal thread quantity varies in accordance with a relatively large number of platform-specific and/or machine-specific attributes. Developing a platform-agnostic model to determine an optimal thread quantity at runtime can become resource-intensive based on the complexity of those attributes, and largely unscalable as data set diversity increases.

For example, in various embodiments and scenarios the optimal thread quantity may vary in accordance with hardware factors such as one or more of the following: CPU frequency, memory clock frequency, memory bandwidth, cross-node memory latency, throughput instruction set (e.g., AVX512 vs AVX2), etc. In addition, in various embodiments and scenarios the optimal thread quantity may vary in accordance with software factors, such as one or more of the following: operating system (OS) type (e.g., hard real-time vs. soft real-time, virtual machine image vs. embedded OS, etc.); threading model (e.g., thread pool vs. standalone threads); thread initiation resource costs; matrix blocking factors; compiler-specific optimizations; etc. Each of these factors varies between computing devices; even within a single computing device, almost all software parameters are configurable.

Embodiments of techniques described herein dynamically determine and implement an estimated optimal thread quantity as a platform-agnostic estimation model for matrix multiplication operations based on dimensions of the input matrices being multiplied, as well as on a relatively low number of kernel parameters that vary, and are tuned, based on processor architecture. The estimated optimal thread quantity (EOTQ) is an estimation of the optimal thread quantity without excessive calculations and without attempting to account for every system, hardware, and software attribute that may affect the value of that optimal thread quantity, as noted above. In particular, embodiments determine an efficient factorization of an estimated optimal thread quantity as

nt=ic_nt*jc_nt

where ic_nt is a number of blocks along a dimension m of a first input matrix A, and where jc_nt is a number of blocks along a dimension n of a second input matrix B, with both numbers being based on kernel parameters and block tuning parameters that specify one or more block dimensions. In certain embodiments, a command processor of a parallel processor determines an estimated optimal thread quantity for performing a matrix multiplication command (MMC) responsive to receiving the MMC, which includes information representative of the first and second input matrices A, B. The command processor then schedules that estimated optimal thread quantity of kernel threads to execute the MMC in parallel.

In various embodiments, the increased thread efficiency (computations performed per thread) associated with such techniques for utilizing the estimated optimal thread quantity offsets thread management and memory contention overheads associated with its dynamic determination, such that the performance from the estimated optimal thread quantity approaches or equals that of the optimal thread quantity in most cases. Such techniques also result in efficient resource utilization, such as to achieve optimal performance using a minimum number of threads. In certain scenarios and embodiments, additional advantages include enabling the development of models for calculating the estimated optimal thread quantity with significantly lower effort than involved in manual tuning, and may operate independently of code changes.

It will be appreciated that although various examples are provided and discussed herein in the context of General Matrix Multiplication (GEMM) and/or Single Precision General Matrix Multiplication (SGEMM), in various embodiments the techniques described herein may be utilized in additional multi-threaded matrix operations and contexts as well, including additional GEMM precisions.

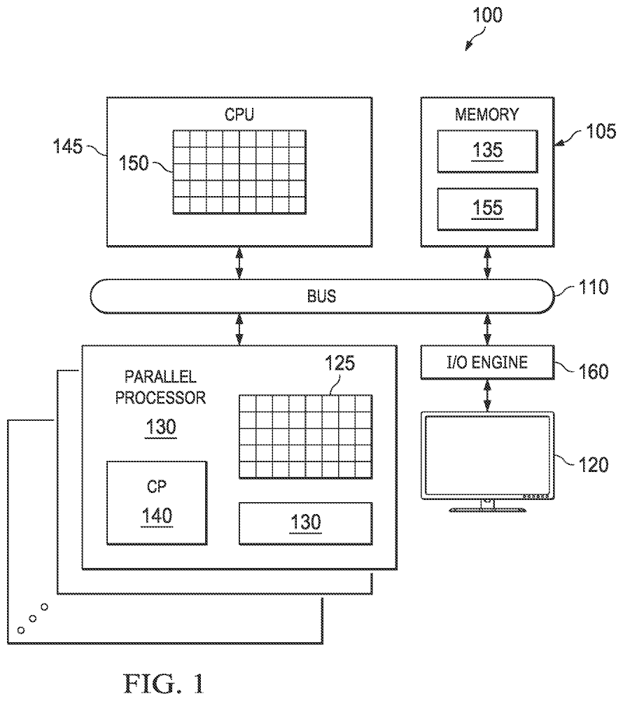

FIG. 1 is a block diagram of a processing system 100 configured to dynamically determine and implement a respective estimated optimal thread quantity for matrix multiplication operations performed in accordance with some embodiments. The processing system 100 is generally configured to execute sets of instructions (e.g., programs) or commands (e.g., draw commands) to carry out tasks on behalf of an electronic device. Accordingly, in different embodiments the processing system 100 is incorporated into one of a variety of electronic devices, such as a desktop computer, laptop computer, server, smartphone, tablet, game console, and the like.

The processing system 100 includes or has access to a memory 105 or other storage component that is implemented using a non-transitory computer readable medium such as a dynamic random access memory (DRAM). However, the memory 105 can also be implemented using other types of memory including static random access memory (SRAM), nonvolatile RAM, and the like. The processing system 100 also includes a bus 110 to support communication between entities implemented in the processing system 100, such as the memory 105. Some embodiments of the processing system 100 include other buses, bridges, switches, routers, and the like, which are not shown in FIG. 1 in the interest of clarity.

The processing system 100 includes one or more parallel processors 115 that are configured to render images for presentation on a display 120. A parallel processor is a processor that is able to execute a single instruction on multiple data or threads in a parallel manner. Examples of parallel processors include processors such as graphics processing units (GPUs), massively parallel processors, single instruction multiple data (SIMD) architecture processors, and single instruction multiple thread (SIMT) architecture processors for performing graphics, machine intelligence or compute operations. In some implementations, parallel processors are separate devices that are included as part of a computer. In other implementations such as advance processor units, parallel processors are included in a single device along with a host processor such as a central processor unit (CPU). Although the below description uses a graphics processing unit (GPU) for illustration purposes, various embodiments and implementations described herein are applicable to other types of parallel processors.

The parallel processor 115 can render objects to produce values of pixels that are provided to the display 120, which uses the pixel values to display an image that represents the rendered objects. Some embodiments of the parallel processor 115 can also be used for general purpose computing. For example, the parallel processor 115 can be used to implement machine learning algorithms such as neural networks. In some cases, operations of multiple parallel processors 115 are coordinated to execute the machine learning algorithm, e.g., if a single parallel processor 115 does not possess enough processing power to run the machine learning algorithm on its own. The multiple processors 115 communicate over one or more interfaces (not shown in FIG. 1 in the interest of clarity).

The parallel processor 115 implements multiple processing elements (also referred to as compute units) 125 that are configured to execute instructions concurrently or in parallel. The parallel processor 115 also includes an internal (or on-chip) memory 130 that includes a local data store (LDS), as well as caches, registers, or buffers utilized by the compute units 125. The internal memory 130 stores data structures that describe tasks executing on one or more of the compute units 125. In the illustrated embodiment, the parallel processor 115 communicates with the memory 105 over the bus 110. However, some embodiments of the parallel processor 115 communicate with the memory 105 over a direct connection or via other buses, bridges, switches, routers, and the like. The parallel processor 115 can execute instructions stored in the memory 105 and the parallel processor 115 can store information in the memory 105 such as the results of the executed instructions. For example, the memory 105 can store a copy 135 of instructions from a program code that is to be executed by the parallel processor 115 such as program code that represents a machine learning algorithm or neural network. The parallel processor 115 also includes a command processor 140 that receives task requests and dispatches tasks to one or more of the compute units 125. The command processor 140 is a set of hardware configured to receive the commands from the CPU 145 and to prepare the received commands for processing. For example, in some embodiments the command processor 140 buffers the received commands, organizes the received commands into one or more queues for processing, performs operations to decode or otherwise interpret the received commands, and the like.

The processing system 100 also includes a central processing unit (CPU) 145 that is connected to the bus 110 and communicates with the parallel processor 115 and the memory 105 via the bus 110. In the illustrated embodiment, the CPU 145 implements multiple processing elements (also referred to as processor cores) 150 that are configured to execute instructions concurrently or in parallel. The CPU 145 can execute instructions such as program code 155 stored in the memory 105 and the CPU 145 can store information in the memory 105 such as the results of the executed instructions. The CPU 145 is also able to initiate graphics processing by issuing commands or instructions (which are sometimes referred to herein as “draw calls”) to the parallel processor 115.

An input/output (I/O) engine 160 handles input or output operations associated with the display 120, as well as other elements of the processing system 100 such as keyboards, mice, printers, external disks, and the like. The I/O engine 160 is coupled to the bus 110 so that the I/O engine 160 communicates with the memory 105, the parallel processor 115, or the CPU 145.

In operation, the CPU 145 issues draw calls to the parallel processor 115 to initiate processing of a kernel that represents the program instructions that are executed by the parallel processor 115 to, for example, perform one or more matrix multiplication operations. Multiple instances of the kernel, referred to herein as threads or work items, are executed concurrently or in parallel using subsets of the compute units 125. In some embodiments, the threads execute according to single-instruction-multiple-data (SIMD) protocols so that each thread executes the same instruction on different data. The threads are collected into workgroups that are executed on different compute units 125. For example, the command processor 140 can receive the draw calls and schedule tasks for execution on the compute units 125.

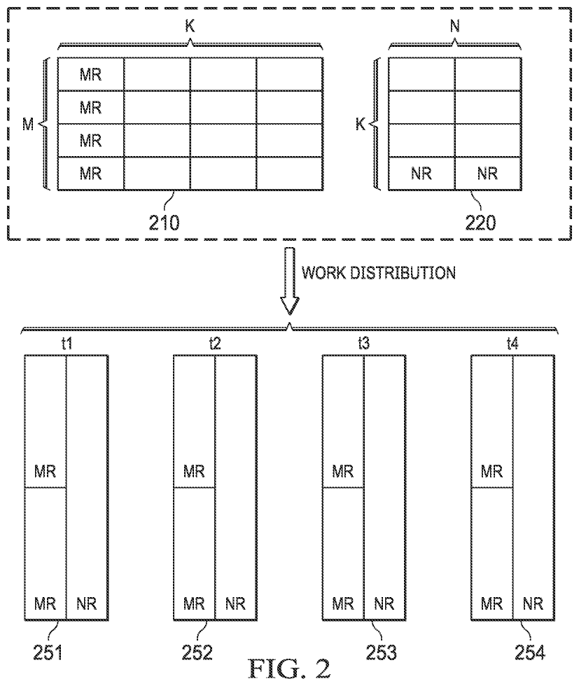

FIG. 2 illustrates an example work distribution for a plurality of kernel threads performing multiplication of an input source matrix 210 and an input weight matrix 220. As expressed in the context of a general matrix multiplication (GEMM) algorithm, an input dimension K quantifies both the number of columns in the input source matrix 210 and the number of rows in the input weight matrix 220. The input source matrix 210 has dimensions M×KC, where M=4*MR; and the input weight matrix 220 has dimensions KC×N, where N=2*NR. Input source matrix 210 is divided into blocks of size MR×K, where K is the number of columns in the input source matrix 210. The input weight matrix 220 is divided into blocks of size KC×NR; here, K corresponds to the number of rows in the input weight matrix 220. The kernel threads process these blocks in parallel to compute the corresponding output blocks of the output matrix (not shown).

The values MR and NR are kernel parameters specifying the size of blocks into which the input matrices 210, 220 are divided for processing in parallel by the kernel threads. The MR and NR parameters specify the size of these blocks in the M and N dimensions, respectively, and thus define the shape of the input matrices 210, 220 to be processed by the kernel. The choice of MR and NR can have a significant impact on the performance and efficiency of the matrix multiplication operation. Optimal values of MR and NR depend on the specific hardware platform and the characteristics of the input matrices.

As depicted in the example of FIG. 2, the multiplication of the input matrices 210, 220 is assigned to four distinct kernel threads 251, 252, 253, 254, each being assigned two MR×KC blocks of the input source matrix 210 and a single KC×NR block of the input weight matrix 220. The data per thread for the kernel threads 251, 252, 253, 254 may be represented as follows:

$$m\_ic \_nt = M / 2 = 2 * MR$$

$$n\_jc \_nt = N / 2 = NR$$

In SGEMM implementations, the matrix multiplication operation is performed using five processing loops iterating over the rows and columns of the input matrices and the output matrix. In particular, the five processing loops may be described as follows for performing matrix multiplication on sub-blocks of a first input matrix A (e.g., input source matrix 210) and second input matrix B (e.g., input weight matrix 220) to determine an output matrix C:

```
for jc = 0 to N, steps of NC:
  for pc = 0 to k, steps of KC:
    for ic = 0 to M, steps of MC:
      for jr = 0 to NC, steps of NR:
        for ir = 0 to MC, steps of MR:
          for kr = 0 to KC, steps of 1:
            C[ ] = C[ ] + (A[ ] * B[ ])
```

where matrix A is the input source matrix 210 and matrix B is the input weight matrix 220. In certain embodiments, the innermost processing loops (ir=0 to MC and kr=0 to KC) are implemented using processor-specific assembly instructions for performance benefits, as well as to split the input matrices 210, 220 into proper cached blocks, which are provided as input to the kernel. Cache blocking results in better performing code, due to reuse of data in cache at multiple levels in the cache hierarchy. The loops are platform agnostic, and are reusable across computing devices, with selectable device-specific cache-blocking parameters (e.g., MR, NR, KC, MC). At each invocation of the kernel, it computes MR×NR blocks of the output matrix C. MC×KC is the A block dimension. KC×NC is the B block dimension. In certain embodiments, the parameters KC, MC, and NC are determined based at least in part on system cache sizes. For example, in an embodiment, KC×NR is selected to be storable in level 1 (L1) cache; MC×KC is selected to be storable within level 2 (L2) cache; and KC×NC is selected to be storable within level 3 (L3) cache.

In certain embodiments, the determination and implementation of the estimated optimal thread quantity is performed such that each thread is provided with at least a minimum amount of work. Because typical computing devices in practice use varying frequency rather than fixed frequency, a minimum amount of work is required for the processing cores of those computing devices to reach peak frequency. In some embodiments, any newly launched thread causes a performance increase that supersedes the increase from reusing L1 or L2 cache by a smaller number of threads.

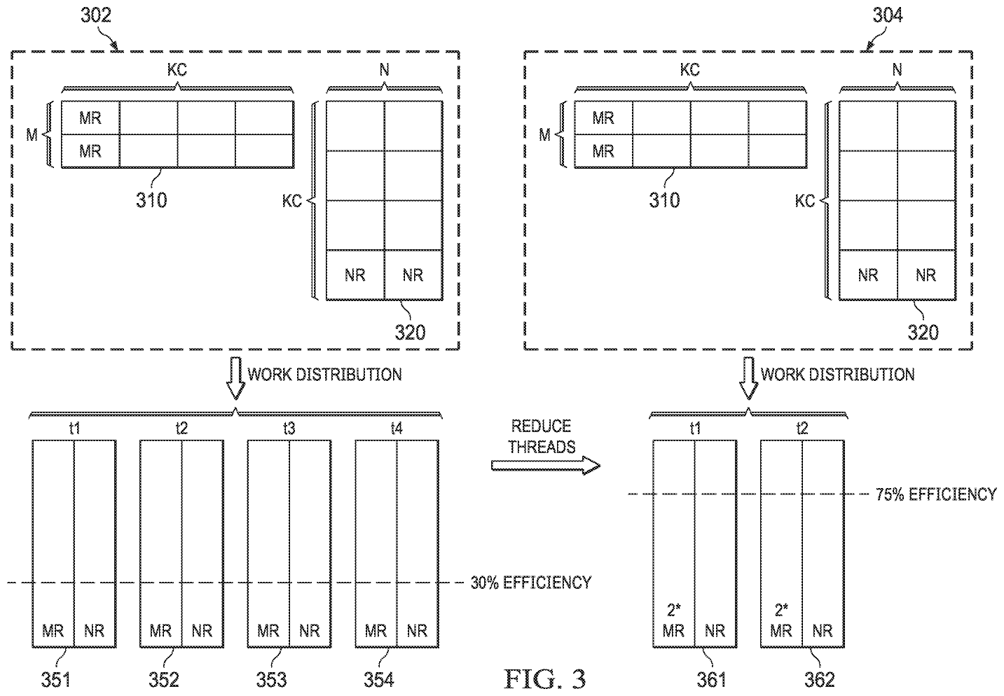

FIG. 3 illustrates two contrasting examples of work distribution for a plurality of kernel threads performing multiplication of an input source matrix 310 and an input weight matrix 320. Input dimension K is iterated in blocks of a kernel parameter KC that quantifies both the number of columns in the input source matrix 310 and the number of rows in the input weight matrix 320, such that K=x*KC. Input source matrix 310 has dimensions M×KC, where M=2*MR; input weight matrix 320 has dimensions KC×N, where N=2*NR. The input source matrix 310 is divided into blocks of size MR×KC; the input weight matrix 320 is divided into blocks of size KC×NR.

In the first example 302 of work distribution in FIG. 3, the multiplication of the input matrices 310, 320 is assigned to four distinct kernel threads 351, 352, 353, 354. Each of the kernel threads 351, 352, 353, 354 is assigned a single MR-sized block and a single NR-sized block. However, low data per thread results in greater memory access overheads and less frequency per processing core, resulting in thread utilization of only 30% efficiency for each of the four kernel threads 351, 352, 353, 354.

In the second example 304 of work distribution in FIG. 3, the multiplication of the input matrices 310, 320 is assigned only two threads 361, 362, each of which is assigned one 2*MR block and one NR block for processing. However, using those two threads increases the relative efficiency of each assigned thread to 75%, compared to the 30% efficiency achieved when the matrix multiplication was assigned to the four threads 351, 352, 353, 354.

In certain embodiments, the determination and implementation of the estimated optimal thread quantity is performed such that work distribution between assigned threads is substantially uniform. The average exit barrier wait time (the time spent by each thread waiting at the end of parallel processing for the other threads of the kernel to complete) can be high when using more than the optimal thread quantity. This increased wait time is typically associated with an imbalance in work distribution among threads.

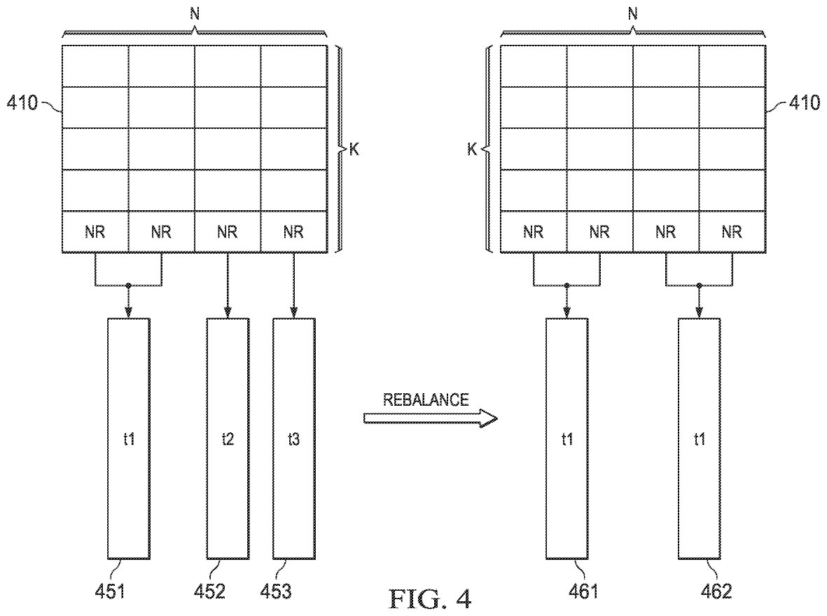

FIG. 4 illustrates two contrasting examples of work distribution for a plurality of kernel threads performing one or more operations on an arbitrary matrix 410. In the first example, the arbitrary matrix 410 is split into three threads 451, 452, 453 for processing, such that thread 451 is assigned two NR-sized blocks while threads 452 and 453 are each assigned a single NR-sized block. In the second example, the arbitrary matrix 410 is split into two threads 461, 462 for processing, such that each thread is assigned two NR-sized blocks.

In the first example, threads 452 and 453 will complete their respective processing in approximately half the time as thread 451 but will be delayed at the exit barrier until thread 451 completes its own processing. In the second example, each of threads 461 and 462 complete their processing of their respective 2*NR blocks at approximately the same time, and in approximately the same amount of time in which thread 451 does so, meaning that in the second example threads 461, 462 provide the same performance as threads 451, 452, 453 in the first example.

In certain embodiments, the determination and implementation of the estimated optimal thread quantity is performed such that threads do not busy-wait or sleep due to lack of work along the M or N dimensions. Busy-waiting is a technique for synchronizing thread execution by repeatedly checking a shared variable or condition until it becomes true, at which point the thread can proceed.

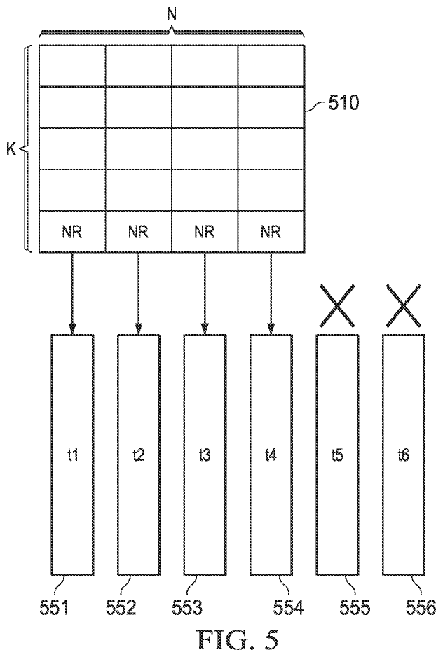

As discussed above, in standard SGEMM factorization, the work along M and N dimensions are distributed in blocks of MR and NR, respectively, in accordance with respective kernel parameters. For some inputs this type of factorization results in certain threads being without any work after block-based work distribution, as shown in FIG. 5.

FIG. 5 illustrates an example of work distribution using standard SGEMM factorization for a plurality of kernel threads performing one or more operations on an arbitrary matrix 510, which can be considered a B matrix such as an input weight matrix. In this example, the arbitrary matrix 510 is divided into thread blocks based on kernel parameter NR, with matrix width N=4*NR. Because of that relationship, threads 551, 552, 553, 554 are each assigned a 5×NR block while threads 555, 556 are idle.

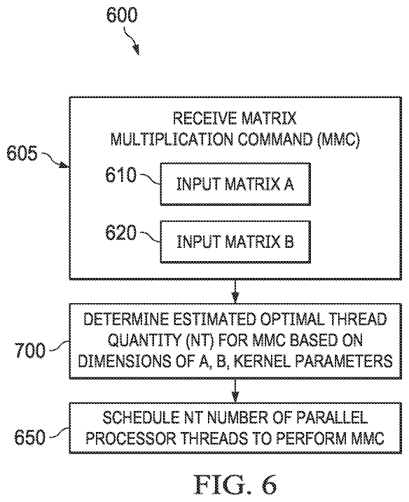

FIG. 6 is a flow diagram illustrating an operational routine 600 for determining and implementing an estimated optimal thread quantity for executing a matrix multiplication kernel operation, in accordance with some embodiments. The operational routine 600 may be performed, for example, by a command processor (e.g., command processor 140 of FIG. 1) of a parallel processor (e.g., parallel processor 115 of FIG. 1).

The routine begins at block 605, in which a matrix multiplication command (MMC) is received by the command processor. The matrix multiplication command includes information representative of a first input matrix A 610 and a second input matrix B 620. The routine proceeds to operational routine 700.

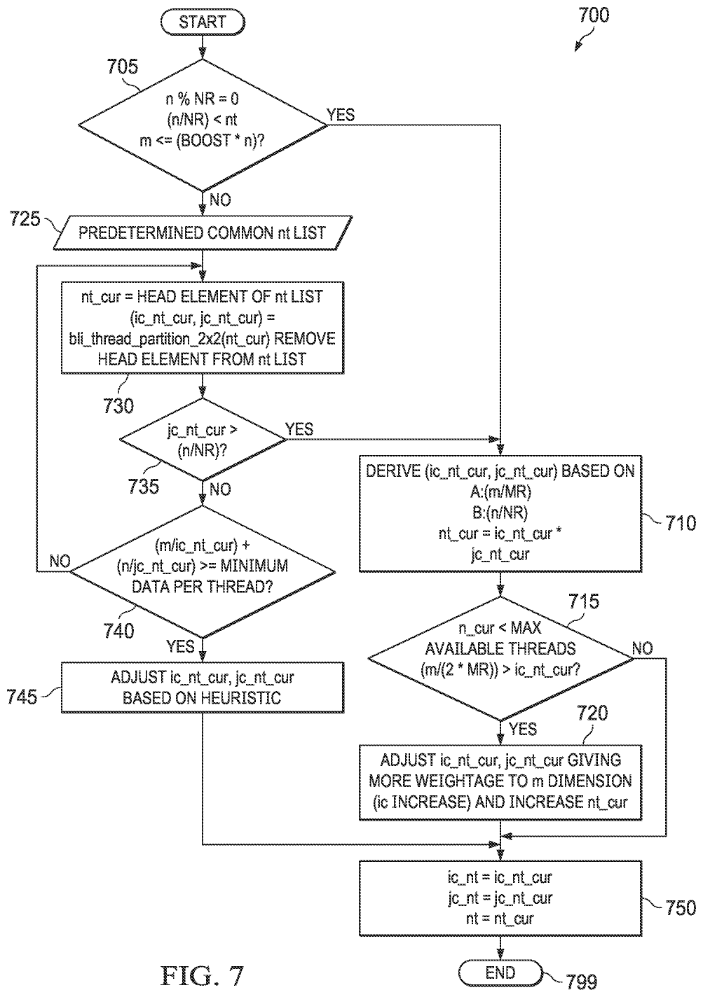

At operational routine 700, the command processor determines an estimated optimal thread quantity NT to use for execution of the matrix multiplication command based on dimensions of the first input matrix A 610, dimensions of the second input matrix B 620, and one or more kernel parameters. Additional details regarding one embodiment of the operational routine 700 are discussed elsewhere herein, including below with respect to FIG. 7. Following the operational routine 700, the operational routine 600 proceeds to block 650.

At block 650, the command processor schedules a subset of parallel processor threads, corresponding to the determined thread quantity NT, to perform the matrix multiplication command.

FIG. 7 is a programmatic flow diagram illustrating an operational routine 700 for determining an estimated optimal thread quantity NT for executing a matrix multiplication kernel operation, in accordance with some embodiments. The operational routine 700 may be performed, for example, by a command processor (e.g., command processor 140 of FIG. 1) of a parallel processor (e.g., parallel processor 115 of FIG. 1). In this and other embodiments, a platform-agnostic estimated optimal thread quantity that encapsulates the aspects described above—minimal work per thread, uniform work distribution between threads, and the mitigation or elimination of busy-wait or sleep time—is determined via efficient factorization as

nt=ic_nt*jc_nt

where ic_nt represents the number of blocks along dimension m of a first input matrix A, and jc_nt represents a number of blocks along dimension n of a second input matrix B, with both ic_nt and jc_nt being based on one or more kernel parameters (e.g., MR, NR, KC) parameters. A minimum work per thread is established in terms of a minimum number of MR×KC and KC×NR blocks subdividing the input A and B matrices, respectively. As for ensuring no threads are launched without work, the number of MR and NR blocks in A and B are respectively calculated, and the parallelization along jc and ic dimensions and subsequently the total number of threads are adjusted with respect to that number of blocks. In the embodiment of FIG. 7, work balancing is primarily considered along the n dimension. This is because in SGEMM kernels, the second input matrix B is loaded instead of the first input matrix A (single element is broadcast), and parallelism occurs for the loaded elements.

The operational routine 700 begins at block 705, in which the command processor determines three conditions: first, whether a dimension n of input matrix B 620 is evenly divisible by a block size indicated by kernel parameter NR, such that n % NR=0; second, whether a number of NR-sized blocks in n is less than an initial value nt, such that (n/NR)<nt; and third, whether a dimension m of input matrix A 610 is less than or equal to n*boost_threshold, where the boost threshold is a processor-specific value. If all three of these conditions are true, the routine proceeds to block 710; if not, the routine proceeds to block 725.

At block 710, the routine determines a unidimensional thread quantity for each of the m and n dimensions. In particular, a value ic_nt_cur is determined as (m/MR) for the first input matrix A 610, and a value jc_nt_cur is determined as (n/NR) for the second input matrix B 620. An estimated thread quantity nt_cur is set as

nt_cur=ic_nt_cur*jc_nt_cur

and the routine proceeds to block 715.

At block 715, the command processor determines whether the estimated thread quantity nt_cur is less than a maximum quantity of currently available threads, and whether each thread (assuming nt_cur is used) will be launched with at least minimal work that is, whether (m/(2*MR)) is greater than ic_nt_cur. If both conditions are true, the routine proceeds to block 720; otherwise, the routine proceeds to block 750.

At block 720, the command processor adjusts the values of ic_nt_cur and jc_nt_cur to give more weight to the m dimension, such as by increasing the value of ic_nt_cur and decreasing the value of jc_nt_cur. The routine proceeds to block 750.

If it was determined at block 705 that a dimension n of input matrix B 620 is not evenly divisible by a block size indicated by kernel parameter NR; that a number of NR-sized blocks in n is greater than an initial value nt; or that a dimension m of input matrix A 610 is greater than boost_threshold*n, then the routine proceeds to block 725 to access a listing of predetermined common thread quantity configurations. For example, the listing may include a set of commonly used thread quantities (e.g., 64, 48, 36, 32, 24, 16, 8, or 4), with the command processor selecting the configuration associated with the largest number of threads that do not exceed the currently maximum available number of threads. After the command processor selects one of the predetermined configurations, the routine proceeds to block 730.

At block 730, the command processor sets the values of ic_nt_cur and jc_nt_cur. Each value in a predefined list of nt values (“nt list”) are checked in descending order to see if that value satisfies the effective threads constraints, such that the largest constraint-satisfying value is selected. The routine proceeds to block 735.

At block 735, the command processor determines whether the value of jc_nt_cur is greater than the quantity of blocks along the n dimension (n/NR). If so, the routine proceeds to block 710, discussed elsewhere herein; if not, the routine proceeds to block 740.

At block 740, the command processor determines whether the workload associated with current estimates for a unidimensional thread quantity for each of the m and n dimensions meets a minimum data per thread threshold, such as to ensure that at least a minimum amount of work is provided in order for the relevant processing cores to reach a peak operating frequency. If the workload does not meet the minimum data per thread threshold, the routine returns to block 730. If the workload does meet the minimum data per thread threshold, the routine proceeds to block 745.

At block 745, the command processor adjusts the values of ic_nt_cur and jc_nt_cur based on a heuristic model derived from one or more historical analyses of GEMM performance associated with various matrix shapes, such as with small and/or skinny matrices. In this manner, the command processor may account for various relationships between the respective dimensions of the input matrices.

After block 720 or block 745, or if it was determined in block 715 either that the estimated thread quantity nt_cur is greater than a maximum quantity of currently available threads, or that one or more threads will be launched without a minimum quantity of work if the estimated thread quantity nt_cur is used, the routine proceeds to block 750.

At block 750, the current estimates for the quantity of threads (both collectively, and individually for each of the m and n dimensions) are determined as the estimated optimal thread quantity NT (and its component quantities ic_nt and jc_nt).

Following block 750, the routine proceeds to block 799 and ends, such as if the command processor proceeds to schedule an NT-sized subset of parallel processor threads to perform the matrix multiplication command in block 650 of operational routine 600 in FIG. 6, discussed elsewhere herein.

In at least one embodiment, the following pseudocode is used as an example implementation of the operational routine 700:

● k_blocks = k / KC
● n_panels = ceiling(n / (min_NR_blocks_threshold * NR))
● Start conditional section

| ◯ | Case 1: | |
|---|---|---|
| | i. | k_blocks is greater than or equal to |
| | | min_MR_blocks_threshold_boost_k |
| | ii. | min_MR_blocks = large_k_min_MR_blocks_threshold |
| ◯ | Case 2: | |
| | i. | k_blocks is less than min_MR_blocks_threshold_boost_k |
| | ii. | min_MR_blocks = min_MR_blocks_threshold |

● End conditional section
● m_blocks = ceiling(m / (min_MR_blocks * MR))
● Start conditional section

| ◯ | Case 1: | |
|---|---|---|
| | i. | n is a perfect multiple of NR |
| | ii. | n_panels is less than max available threads |
| | iii. | k is greater than or equal to k_min_work_threshold |
| | iv. | m is less than or equal to (n_boost_threshold * n) |
| | v. | ( ic_nt, jc_nt, nt, nt_adjusted ) = n_panel_based_derivation(m_blocks, |
| | | n_panels, k, KC, max available threads) |
| | vi. | ( ic_nt, jc_nt, nt ) = adjust_factorization_to_use_more_threads(m, |
| | | m_blocks, n, n_panels, k > KC, nt_adjusted, ic_nt, jc_nt, nt) |
| ◯ | Case 2: | |
| | i. | Default case |
| | ii. | common_num_threads = [64, 48, 36, 32, 24, 16, 8, 4] |
| | iii. | usable_num_threads = Remove elements from |
| | | common_num_threads greater than max available threads |
| | iv. | min_work_satisfied = false |
| | v. | iterate over usable_num_threads elem at a time till |
| | | min_work_satisfied is false: |

| | |
|---|---|
| a. | ( ic_nt, jc_nt ) = bli_thread_partition_2x2( elem, m, n, .. ) |
| b. | nt <− elem |
| c. | Start conditional section |

| | |
|---|---|
| 1. | Case 2.1: |

| | |
|---|---|
| i. | jc_nt is greater than or equal to n_panels |
| ii. | k is greater than k_min_work_threshold |
| iii. | ( ic_nt, jc_nt, nt, nt_adjusted ) = |
| | n_panel_based_derivation(m_blocks, n_panels, |
| | k, KC, elem) |
| iv. | ( ic_nt, jc_nt, nt ) = |
| | adjust_factorization_to_use_more_threads(m, |
| | m_blocks, n, n_panels, k > KC, nt_adjusted, |
| | ic_nt, jc_nt, nt) |

| | |
|---|---|
| 2. | Case 2.2: |

| | |
|---|---|
| i. | k is greater than or equal to KC |
| ii. | m_ic_nt = floor( ( m / ic_nt ) * k_blocks ) |
| iii. | n_jc_nt = floor( ( n / jc_nt ) * k_blocks ) |
| iv. | if ( m_ic_nt + n_jc_nt ) is greater than or equal |
| | to min_work_for_full_k_block_threshold: |

| | |
|---|---|
| 1. | min_work_satisfied = true |
| 2. | (ic_nt, jc_nt) = |
| | adjust_factorization_based_on_heuristi |
| | c(m, n, k, nt, ic_nt, jc_nt) |
| 3. | break out of iteration |

| | |
|---|---|
| 3. | Case 2.3 |

| | |
|---|---|
| i. | k is less than KC |
| ii. | m_ic_nt = floor( m / ic_nt ) |
| iii. | n_jc_nt = floor( n / jc_nt ) |
| iv. | Start conditional section |

| | |
|---|---|
| 1. | Case 2.3.1: |

| | |
|---|---|
| i. | k is greater than or equal to |
| | k_min_work_threshold |
| ii. | if ( m_ic_nt + n_jc_nt ) is greater |
| | than or equal to |
| | min_work_for_full_k_block_thre |
| | shold: |

| | |
|---|---|
| 1. | min_work_satisfied = |
| | true |
| 2. | (ic_nt, jc_nt) = |
| | adjust_factorization_bas |
| | ed_on_heuristic(m, n, k, |
| | nt, ic_nt, jc_nt) |
| 3. | break out of iteration |

| | |
|---|---|
| 2. | Case 2.3.2: |

| | |
|---|---|
| i. | k is less than |
| | k_min_work_threshold |
| ii. | k_partial_block_boost_threshold |
| | = minimum of(64, (KC / ( k * 4 ))) |
| iii. | if ( m_ic_nt + n_jc_nt ) is greater |
| | than or equal to |
| | (min_work_for_full_k_block_thr |
| | eshold * |
| | k_partial_block_boost_threshold |
| | ): |

| | |
|---|---|
| 1. | min_work_satisfied = |
| | true |
| 2. | (ic_nt, jc_nt) = |
| | adjust_factorization_bas |
| | ed_on_heuristic(m, n, k, |
| | nt, ic_nt, jc_nt) |
| 3. | break out of iteration |

| | |
|---|---|
| v. | End conditional section |

| | |
|---|---|
| d. | End conditional section |

● End conditional section

Sub Algorithm: n_panel_based_derivation(m_blocks, n_panels, k, KC, max available threads):

● n_panels_adjusted = n_panels
● m_blocks_adjusted = m_blocks
● nt_adjusted = max available threads
● Start conditional section

| ◯ | Case 1: | |
|---|---|---|
| | i. | k is less than or equal to k_block_min_work_threshold |
| | ii. | k_reduction_factor_for_m = 2 |
| | iii. | k_reduction_factor_for_n = 2 |
| | iv. | if n is greater than (m_boost_threshold * m): |
| | | a. k_reduction_factor_for_n = 1 |
| | v. | else: |
| | | a. k_reduction_factor for m = 1 |
| | vi. | if k is less than or equal to n_favour_k_block_min_work_threshold: |
| | | a. k_reduction_factor_for_m = 2 |
| | | b. k_reduction_factor_for_n = 2 |
| | vii. | n_panels_adjusted = ceiling(n_panels / k_reduction_factor_for_n) |
| | viii. | m_blocks_adjusted = ceiling(m_blocks / k_reduction_factor_for_m) |
| | ix. | nt_adjusted = minimum of( max available threads, |
| | | (n_panels_adjusted * m_blocks_adjusted)) |

● End conditional section
● jc_nt = n_panels_adjusted
● ic_nt = minimum of(m_blocks_adjusted, floor(nt_adjusted / jc_nt))
● nt = ic_nt * jc_nt

Sub Algorithm: adjust_factorization_to_use_more_threads(m, m_blocks, n, n_panels,

● jc_for_use = n_panels
● orig_jc = jc_nt
● orig_work_per_thread = (m / ic_nt) + (n / jc_nt)
● prev_jc = largest factor of jc_for_use smaller than jc_nt
● if prev_jc equals 1:

| | |
|---|---|
| ◯ | prev_jc = (jc_nt + 1)/ 2 |

● next_ic = floor(max available threads / prev_jc)
● next_nt = prev_jc * next_ic
● cur_work_per_thread = (m / next_ic) + (n / prev_jc)
● Start conditional section

| ◯ | Case 1: | |
|---|---|---|
| | i. | next_ic less than or equal to m_block |
| | ii. | next_nt greater than ( nt + perf_gain_thread_count_increment ) |
| | iii. | cur_work_per_thread is less than orig_work_per_thread |
| | iv. | ic_nt = next_ic |
| | v. | jc_nt = prev_jc |
| | vi. | nt = ic_nt * jc_nt |
| | vii. | orig_work_per_thread = cur_work_per_thread |

● End conditional section
● prev_prev_jc = largest factor of jc_for_use smaller than prev_jc
● if prev_prev_jc equals 1:

| | |
|---|---|
| ◯ | prev_prev_jc = (prev_jc + 1)/ 2 |

● next_next_ic = floor(max available threads / prev_prev_jc)
● next_next_nt = prev_prev_jc * next_next_ic
● cur_work_per_thread = (m / next_next_ic) + (n / prev_prev_jc)
● Start conditional section

| ◯ | Case 1: | |
|---|---|---|
| | i. | next_next_ic less than or equal to m_block |
| | ii. | next_next_nt greater than ( nt + perf_gain_thread_count_increment ) |
| | iii. | cur_work_per_thread is less than orig_work_per_thread |
| | iv. | ic_nt = next_next_ic |
| | v. | jc_nt = prev_prev_jc |
| | vi. | nt = ic_nt * jc_nt |
| | vii. | orig_work_per_thread = cur_work_per_thread |

● End conditional section
● prev_prev_prev_jc = largest factor of jc_for_use smaller than prev_prev_jc
● if prev_prev_prev_jc equals 1:

| | |
|---|---|
| ◯ | prev_prev_prev_jc = (prev_prev_jc + 1)/ 2 |

● next_next_next_ic = floor(max available threads / prev_prev_prev_jc)
● next_next_next_nt = prev_prev_prev_jc * next_next_next_ic
● cur_work_per_thread = (m / next_next_next_ic) + (n / prev_prev_prev_jc)
● Start conditional section

| ◯ | Case 1: | |
|---|---|---|
| | i. | is not a full KC block ((k < KC) : full_KC_block = false) |
| | ii. | next_next_next_ic less than or equal to m_block |
| | iii. | next_next_next_nt greater than ( nt + |
| | | perf_gain_thread_count_increment ) |

```
  OR
  next_next_next_nt greater than or equal to nt and orig_jc is less than
  n_panels
  m > n
```

● cur_work_per_thread is less than orig_work_per_thread
● ic_nt = next_next_next_ic
● jc_nt = prev_prev_prev_jc
● nt = ic_nt * jc_nt
● End conditional section

Sub Algorithm: - adjust_factorization_based_on_heuristic(m, n, k, nt, ic_nt, jc_nt)

● cur_work_per_thread = floor(m / ic_nt) + floor(n / jc_nt)
● prev_jc = largest factor of nt smaller than jc_nt
● next_ic = floor(nt / prev_jc)
● next_ic_work_per_thread = floor(m / next_ic) + floor(n / prev_jc)
● prev_ic = largest factor of nt smaller than ic_nt
● next_jc = floor(nt / prev_ic)
● next_jc_work_per_thread = floor(m / prev_ic) + floor(n / next_jc)
● Start conditional section

| ◯ | Case 1: | |
|---|---|---|
| | i. | ic_nt greater than 1 |
| | ii. | jc_nt less than nt |
| | iii. | Start conditional section |

| | |
|---|---|
| a. | Case 1: |

| 1. | next_jc_work_per_thread is less than |
|---|---|
| | cur_work_per_thread |
| 2. | (n / next_jc) is greater than or equal to NR |
| 3. | can_increase_jc = true |

| | iv. | End conditional section |
|---|---|---|
| ◯ | Case 2: | |
| | i. | ic_nt less than nt |
| | ii. | jc_nt greater than 1 |
| | iii. | (m / next_ic) is greater than (min_MR_blocks_threshold * MR) |
| | iv. | k_factor = k / KC |
| | v. | Start conditional section |

| | |
|---|---|
| a. | Case 1: |

| 1. | (m / ic_nt) is greater than MC |
|---|---|
| 2. | (m / next_ic) is less than or equal to MC |
| 3. | k_factor is greater than |
| | min_k_blocks_for_ic_boost_threshold |
| 4. | can_increase_ic = true |

| | |
|---|---|
| b. | Case 2: |

| 1. | m is greater than (m_heuristic_boost_threshold * n) |
|---|---|
| 2. | (m / ic_nt) is greater than or equal to |
| | (m_cache_block_factor_threshold * MC) |
| 3. | k_factor is greater than |
| | min_k_blocks_for_ic_boost_threshold |
| 4. | (n / prev_jc) less than or equal to |
| | n_good_cache_zone_threshold if (m / jc_nt) held that |
| | condition |
| 5. | can_increase_ic = true |

| | |
|---|---|
| c. | Case 3: |

| 1. | next_ic_work_per_thread is less than or equal to |
|---|---|
| | cur_work_per_thread |
| 2. | can_increase_ic = true |

| | vi. | End conditional section |
|---|---|---|
| ◯ | Case 3: | |
| | i. | n is a perfect multiple of bad_cache_replacement_stride |
| | ii. | m is a perfect multiple of bad_cache_replacement_stride |
| | iii. | k is greater than KC |
| | iv. | Start conditional section |

| | |
|---|---|
| a. | Case 1: |

| | |
|---|---|
| 1. | can_increase_ic is true |
| 2. | (n / jc_nt) is greater than or equal to NR |
| 3. | can_increase_ic = false |

| | |
|---|---|
| b. | Case 2: |

| | |
|---|---|
| 1. | can_increase_jc is false |
| 2. | (n / next_jc) is greater than or equal to NR |
| 3. | can_increase_jc = true |

| | |
|---|---|
| v. | End conditional section |

● End conditional section
● Start conditional section

| ◯ | Case 1: | |
|---|---|---|
| | i. | can_increase_ic is true |
| | ii. | ic_nt = next_ic |
| | iii. | jc_nt = prev_jc |
| ◯ | Case 2: | |
| | i. | can_increase_jc is true |
| | ii. | can_increase_ic is false |
| | iii. | ic_nt = prev_ic |
| | iv. | jc_nt = next_jc |

● End conditional section

In some embodiments, the apparatus and techniques described above are implemented in a system including one or more integrated circuit (IC) devices (also referred to as integrated circuit packages or microchips). Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A command processor configured to:
receive a matrix multiplication command to generate an output matrix by multiplying a first input matrix and a second input matrix using a plurality of threads executing at a parallel processor;
determine an estimated optimal thread quantity for the matrix multiplication command based on dimensions of the first input matrix, dimensions of the second input matrix, and one or more kernel parameters; and
schedule a subset of the plurality of threads to execute the matrix multiplication command at the parallel processor, wherein the subset corresponds to the determined estimated optimal thread quantity.

2. The command processor of claim 1, wherein the estimated optimal thread quantity is less than a quantity of available threads of the plurality of threads.

3. The command processor of claim 1, wherein the kernel parameters include a first block size along a first dimension of the first input matrix and a second block size along a second dimension of the second input matrix that is orthogonal to the first dimension, and wherein to determine the estimated optimal thread quantity comprises to determine the first block size and the second block size.

4. The command processor of claim 1, wherein to determine the estimated optimal thread quantity for the matrix multiplication command includes to determine a thread quantity associated with at least a minimum threshold of work provided to each thread of the scheduled subset.

5. The command processor of claim 1, wherein the command processor is further configured to assign a substantially uniform quantity of work to each thread of the scheduled subset of threads.

6. The command processor of claim 1, wherein to determine the estimated optimal thread quantity for the matrix multiplication command includes to determine an estimated thread quantity for the matrix multiplication command, and to modify the estimated thread quantity based on a heuristic model.

7. The command processor of claim 6, wherein the heuristic model is based on one or more historical analyses of General Matrix Multiplication (GEMM) performance associated with one or more matrix shapes.

8. A method comprising:
receiving a matrix multiplication command to generate an output matrix by multiplying a first input matrix and a second input matrix using a plurality of threads of a kernel executing at a parallel processor;
determining an estimated optimal thread quantity for the matrix multiplication command based on dimensions of the first input matrix, dimensions of the second input matrix, and one or more kernel parameters; and
scheduling a subset of the plurality of threads to perform the matrix multiplication command at the parallel processor, the subset corresponding to the determined estimated optimal thread quantity.

9. The method of claim 8, wherein determining the estimated optimal thread quantity for the matrix multiplication command includes determining an estimated optimal thread quantity that is less than a quantity of available threads of the plurality of threads.

10. The method of claim 8, wherein the kernel parameters include a first block size along a first dimension of the first input matrix and a second block size along a second dimension of the second input matrix that is orthogonal to the first dimension, and wherein determining the estimated optimal thread quantity includes determining the first block size and the second block size.

11. The method of claim 8, wherein determining the estimated optimal thread quantity for the matrix multiplication command includes determining a thread quantity associated with at least a minimum threshold of work being provided to each thread of the scheduled subset.

12. The method of claim 8, further comprising assigning a substantially uniform quantity of work to each thread of the scheduled subset of threads.

13. The method of claim 8, wherein determining the estimated optimal thread quantity for the matrix multiplication command includes determining an estimated thread quantity for the matrix multiplication command, and modifying the estimated thread quantity based on a heuristic model.

14. The method of claim 13, wherein modifying the estimated thread quantity based on a heuristic model includes modifying the estimated thread quantity using a heuristic model that is based on one or more historical analyses of General Matrix Multiplication (GEMM) performance associated with one or more matrix shapes.

15. A processing system, comprising:
a parallel processor comprising:
a plurality of compute units; and
a command processor configured to:
receive a matrix multiplication command to generate an output matrix by multiplying a first input matrix and a second input matrix using a plurality of threads of a kernel executing on one or more compute units of the plurality of compute units;
determine an estimated optimal thread quantity for the matrix multiplication command based on dimensions of the first input matrix, dimensions of the second input matrix, and one or more kernel parameters; and
schedule a subset of the plurality of threads to execute the matrix multiplication command at the parallel processor, wherein the subset corresponds to the determined estimated optimal thread quantity.

16. The processing system of claim 15, wherein the estimated optimal thread quantity is less than a quantity of available threads of the plurality of threads.

17. The processing system of claim 15, wherein the kernel parameters include a first block size along a first dimension of the first input matrix and a second block size along a second dimension of the second input matrix that is orthogonal to the first dimension, and wherein to determine the estimated optimal thread quantity includes to determine the first block size and the second block size.

18. The processing system of claim 15, wherein to determine the estimated optimal thread quantity for the matrix multiplication command includes to determine a thread quantity associated with at least a minimum threshold of work provided to each thread of the scheduled subset.

19. The processing system of claim 15, wherein the command processor is further configured to assign a substantially uniform quantity of work to each thread of the scheduled subset of threads.

20. The processing system of claim 15, wherein to determine the estimated optimal thread quantity for the matrix multiplication command includes to determine an estimated thread quantity for the matrix multiplication command, and to modify the estimated thread quantity based on a heuristic model.
